(19) United States
(12) Patent Application Publication
(10) Pub. No.: US 2024/0035594 A1
(43) Pub. Date: Feb. 1, 2024

(54) TUBING CONNECTOR FOR COMPOSITE TUBING, COMPOSITE TUBING, AND METHODS OF USING THE SAME

(71) Applicant: STICHTING ADMINISTRATIEKANTOOR CRA, Almere (NL)

(72) Inventor: Emile BURNABY LAUTIER, Almere (NL)

(21) Appl. No.: 18/264,258

(22) PCT Filed: Feb. 4, 2022
(86) PCT No.: PCT/EP2022/052770

§ 371 Date: Aug. 4, 2023

(30) Foreign Application Priority Data
Feb. 5, 2021 (NL) 2027502

(51) Int. Cl. F16L 9/147; F16L 13/16

(52) U.S. Cl. CPC F16L 9/147; F16L 13/16

(57) ABSTRACT

A tubing segment is provided for construction of tubing for transporting a fluid, and a tubing connector, tubing for carrying a fluid, the tubing comprising a plurality of tubing segments, a production or injection installation comprising a subsurface well and tubing, methods of manufacturing tubing, methods of connecting two tubing segments, and a method of producing mineral oil or natural gas from a subsurface reservoir, such as a well.

### FIELD OF THE INVENTION

The invention relates generally to a tubing segment for construction of tubing for transporting a fluid, and more particularly to a tubing connector, tubing for carrying a fluid, the tubing comprising a plurality of tubing segments, a production or injection installation comprising a subsurface well and tubing, methods of manufacturing tubing, methods of connecting two tubing segments, and a method of producing mineral oil or natural gas from a subsurface reservoir, such as a well.

### BACKGROUND OF THE INVENTION

There is a general and ongoing need to improve fluid transportation through hostile environments. Examples of hostile environments are seawater or subsurface reservoirs such as wells, particularly mineral oil wells and natural gas wells. Wells are generally deep and have highly corrosive characteristics as well as high temperatures. While seawater has generally low and predictable temperatures, the salt water environment is highly corrosive. As a result of these hostile environments, tubing used for the transportation of fluids through these environments are often quickly damaged and subject to regular workovers and replacements.

Known tubing for transporting fluids is generally metallic. Metallic tubulars have been used for oil/gas transportation since the inception but are particularly prone to corrosion. Corrosion is the largest asset value eroding item in fluid transportation, both downhole as well as subsea. As a result of corrosion, expensive intervention repairs are required during the life of a fluid transportation tubing. As a result, an operator is faced with many health, safety, and environment hazards, and extremely high repair costs per tubing. Workovers, which are required to deal with the highly corrosive nature of the downhole and subsea environment, when traditional tubing is used, are a major source of pollution and result in increased operational risks. Due to the use of traditional tubing for fluid transportation, operators are often faced with the requirement of costly workovers about every two to seven years.

Known tubing for the transportation of fluids is composed of many separate segments, often of equal length. Indeed, with conventional tubing, hundreds of tubing segments may be deployed, which must all be connected to one another. This results in the use of a high number of connections between the separate parts of the tubing. As a result, connectors of the tubing segments also heavily influence the required workover and replacements. Since so many connections are required, the material choices and intricacies of the manufacturing process are severely restricted. As a result, known tubing utilizes low-grade and cheap steel for the connections and the tubing, optionally coated with complex and expensive coatings and cladding aimed at protecting against corrosion. The known coatings and cladding are generally too expensive and do not sufficiently limit the effects of corrosion.

A further important problem of the limited life of tubing as a result of corrosion relates to total fluid production. For example, in downhole applications, if the life of tubing is lower than the well life, the well operator will be faced with the choice of additional investments when the well is not at the end of its life. In many cases, the well operator may decide to terminate all subsurface production since the investment in additional workovers is too large in relation to the remaining downhole fluid. This leads to a permanent loss of oil or gas. The short service life of the known tubing thus may induce a higher total permanent oil/gas loss. The same applies to subsea fluid transportation, where the tubing is also affected by the corrosive nature of the sea water. Here as well, workover or replacement investments may lead to premature abandonment of an oil or gas supply.

Further, in known tubing, connectors generally comprise threads to screw one tubing segment into another. The action of screwing a tubing segment into another tubing segment is performed by gripping machinery. To ensure that these connections do not leak under the high internal pressures, the torsional force applied to the threaded connections by the gripping machinery is extremely large. To this end, gripping force of the gripping machinery performing this action is also large. This, in turn, means that connectors and/or tubing that are gripped by the gripping machinery are prone to damage. To counteract the large gripping force, the connectors must have a gripping surface of thick, strong material to withstand the immense forces applied to the connectors/tubing by the gripping machinery. Because so much material is required, using a higher grade material entails an enormous increase in costs. In particular since many connections are required for segmented tubing, an increase in material costs can quickly drain the profitability of the tubing operation.

Known tubing for transporting is also heavy. Since generally tubing segments, and its connectors, are made from steel, the total weight of the completed tubing is very high. For downhole applications, this leads to incredibly high tensile forces on the machinery at the surface. For subsea operations, the tubing is generally suspended from a vessel or a buoyancy tank, which both have restrictions with regard to their maximum buoyancy. As a result of their weight, only a limited number of risers can be deployed, either directly to a vessel or to a buoyancy tank. This results in a large limitation on the efficiency of operations. It shall be appreciated that an increase in buoyancy of the tanks or the vessel results in higher costs and will lead to additional engineering and production challenges.

Various attempts have been made to address this desire for improved fluid transportation tubing. To counteract the negative effects of corrosion in the known tubing, expensive and complex coatings and/or cladding operations have been utilized. These solutions did not prove to be effective against the problems described above and are expensive. Alternatively, highly expensive materials are used in an attempt to counteract the negative influences of corrosion. These materials are generally very expensive to use since the threaded connectors require a high amount of material for the gripping machinery to connect the tubing segments.

Tubing applications which are not aimed at subsurface fluid retrieval have adopted composite tubulars, such as risers, jumpers and onshore flowlines. While composite tubulars generally result in lower weight, their connectors remain a cause for concern. The corrosive problems with regard to the connectors are still not solved. Also, a threaded connection for a composite tubing requires a very large connector. The gripping machinery cannot apply the required forces to the composite material because it will be damaged. As a result, the connector should comprise a very large area having thick and strong material for the gripping machinery to apply pressure on. The required additional material leads to high costs.

Spoolable composite tubulars have also been proposed for off-shore applications. Spoolable composite tubing generally reduces the need for a large number of connectors. For off-shore applications, the spooling provides logistical problems and long loading times in harbors, which increases total operational costs.

These known composite spoolable tubing applications have not been provided in downhole completions due to the inhospitable conditions, such as extreme pressures, high temperatures, and high axial tensile loads, and corrosive environments. Also, the known tubing, used for other applications than downhole applications, are known to have very large tubing connectors.

Other known tubing connectors use hydraulic snap fit connections. These known tubing connectors are generally made from steel and welded to the steel tubing parts. As a result, these known tubing connectors are still very heavy. Also, the problem of corrosion is not solved, leading to high workover and replacement costs, as described above.

There thus is a need for improved tubing segments and tubing connectors.

### BRIEF SUMMARY OF THE INVENTION

In one aspect of the invention, there is provided a tubing segment for construction of tubing for transporting a fluid, the tubing segment comprising; a sheath comprising; an inner liner; an outer wall; a first open end; and a second open end, said sheath extending between the first open end and the second open end; and a tubing connector, wherein the first open end of the sheath is connected to the tubing connector, said tubing connector comprising: a male coupling end having a tapered outer surface, wherein said tapered outer surface has a decreasing diameter, moving away from the first open end of the sheath; or a female coupling end having a flared inner surface, wherein said flared inner surface has an increasing diameter, moving away from the first open end of the sheath, wherein said tapered outer surface or said flared inner surface comprises a number of attachment members, said number of attachment members being arranged to interlock with an opposing set of attachment members on a surface of an opposing tubing connector.

The term tapered refers to any shape wherein the overall diameter of the outer surface of the male coupling end decreases, moving away from the sheath. In a preferred embodiment, the diameter decreases linearly. The term flared refers to any shape wherein the overall diameter of the inner surface of the female coupling end increases, moving away from the sheath. In a preferred embodiment, the diameter increases linearly.

The sheath comprising an inner liner and an outer wall may aid in the avoidance of potential cracks in the outer wall. When the sheath of the tubing segment is exposed to very high wall stresses, micro cracks may form in the outer wall. The liner will ensure that those cracks do not result in leakage, thus resulting in an improved loadbearing capacity. These very high stresses can be caused by internal pressure or tensile load on the tubing. Avoiding or reducing these micro cracks may provide a longer life expectancy and a greater ability to withstand external stresses. Also, the provision of a liner with an outer wall ensures that the total average density of the tubing segment may be reduced, without compromising on strength, corrosion resistance, and structural integrity.

Since the tubing segment comprises a tubing connector having tapered/flared surfaces, a tubing connector having a male coupling end may be pushed into a tubing connector having a female coupling end. By virtue of such a coupling mechanism, the need for a threaded connection is omitted. In particular, the need for high torsional loads and thus high gripping strength is omitted. As a result, the gripping mechanism for coupling two tubing segments may use the outer wall of the sheath to grip on to. Since the gripping force is low, the outer wall of the sheath is less prone to damage by the gripping machinery. The omission of a gripping surface on the connector ensures that a smaller connector may be used, thereby reducing the material costs of the tubing connector.

The first open end and the second open end of the sheath are opposed to each other, having the sheath extending therebetween. In an embodiment, the cross-section of the tubing is round. The male coupling end has a tapered outer surface and the female coupling end has a flared inner surface. This ensures that the tapered outer surface of the male coupling end can partially be inserted into the flared inner surface of the female coupling end without substantial force being applied.

In an embodiment, the tubing segment further comprises a second tubing connector, wherein the second open end of the sheath is connected to the second tubing connector, said second tubing connector comprising: a male coupling end having a tapered outer surface, wherein said tapered outer surface has a decreasing diameter, moving away from the first open end of the sheath; or a female coupling end having a flared inner surface, wherein said flared inner surface has an increasing diameter, moving away from the first open end of the sheath, wherein said tapered outer surface or said flared inner surface comprises a number of attachment members, said number of attachment members being arranged to interlock with an opposing set of attachment members on a surface of an opposing tubing connector.

The tapered outer surface or said flared inner surface comprises a number of attachment members. These attachment members engage with opposing attachment members of an opposing tubing connector to ensure that two tubing segments are connected. These attachment members may in some embodiments by circumferential grooves. In other embodiments, these attachment members may comprise dog-clutch like teeth, fitted pins, keys, splines and interlocked thread systems, all used in isolation or in any combinations. In an embodiment, attachment members may interlock by application of an axial force. For example, two opposing attachment members may comprise barb-like elements that interlock when they slide past one another.

In an embodiment, the first open end of the sheath is connected to a tubing connector comprising a male coupling end and the second open end of the sheath is connected to a second tubing connector comprising a female coupling end. This ensures that only a single type of tubing segment need be produced since all tubing segments are arranged to be connected to any other tubing segments. In an alternative embodiment, a tubing segment comprises tubing connector with a male coupling end on both ends of the sheath. These tubing segments may then be connected to a tubing segment having a tubing connector with a female coupling end. Alternatively, the tubing segment may be connected to a separate intermediate connecting device having a female coupling end on both sides. In this embodiment, the tubing segment having tubing connectors with male coupling ends may be produced, which are connected to the intermediate connecting device. In another embodiment, tubing segments may be provided with tubing connectors having female coupling ends, which may be connected to intermediate coupling devices having two opposing male coupling ends. It shall be understood that tubing segments with various combinations of tubing connectors with male and/or female coupling ends fall within the present disclosure.

In an embodiment, the female coupling end comprises a passage connecting an outer surface of the female coupling end to the flared inner surface, said passage being arranged to allow pressurized fluid to be injected between the flared inner surface of the female coupling end and a tapered outer surface of a male coupling end of an opposing tubing connector. This arrangement allows for a better fit between two connectors. The passage allows for pressurized fluid to be injected in the space between the opposing surfaces of the male and the female coupling ends, thereby forcing the two opposing surfaces away from one another. This creates the space required to move the attachment members of two opposing coupling ends in an aligned position. Because the surfaces are moved apart by the fluid, the coupling ends no longer need to rely on the forces applied to the attachment members by axial pressure alone. The pressurized fluid allows the attachment members to be axially aligned, without damaging the attachment members. This ensures that margins of the attachment members may be more accurately manufactured, resulting in a tighter fit, or even a negative clearance, between the two components. Once the attachment members are axially aligned, the pressure of the fluid is released, thereby reducing the distance between the surfaces of the opposing coupling ends, and ensuring a solid interlock of the attachment members.

In an embodiment, the attachment members are circumferential grooves. In a preferred embodiment, the circumferential grooves are axially spaced. In this embodiment, the grooves define circles over the tapered outer and/or flared inner surface, said circles defining an area substantially orthogonal to a longitudinal direction of the tubing. These grooves are thus non-helical and cannot be threaded into one another. As a result, the tubing connectors, once attached to one another, cannot be unscrewed. As a result, a solid fit is achieved, with a significantly reduced risk of leakage and a reduction of potential damage to the tubing connectors during the process of connecting the tubing segments. Also, these type of connectors lead to significant improvements in fatigue performance than other connector types.

In an embodiment, the inner liner comprises an isotropic material. The term isotropic material is understood to entail that the material has mechanical properties in all directions, which do not substantially vary. This is beneficial to the working principle of the tubing since the ductility will be equal in all directions. As a result, the liner is able to ensure the integrity of the tubing, regardless of the specific loads that act on it.

In an embodiment, the inner liner has a rupture strain rate of more than about 0.5%, preferably of more than about 5%, more preferably of more than about 20%. The rupture strain rate is measured at 20 degrees Celsius. Having an inner liner with a rupture strain rate of the above values ensures that the outer wall of the tubing can withstand very high stresses. The allowable stresses are far beyond the stress level at which micro cracks are formed in the outer wall without causing the tubing to start leaking through those cracks. Depending on the liner material, the strain rate can be in the elastic as well as in the plastic deformation range.

In an embodiment, the inner liner may comprise metal and/or metal alloys. By providing the inner liner with metal and/or metal alloys, the structural characteristics of the tubing are improved which provides a reduction of the disadvantageous effects of microcracks while providing sufficient flexibility to ensure e.g. slight bending of the completed pipe. Pipe refers to the completed product, comprising a multiplicity, i.e. two or more, tubing segments. Bending and or periodic manipulation may be particularly important in off-shore applications wherein the pipe should withstand the periodic movements of a vessel in relation to the ocean floor. Also, particularly in the application of risers in off-shore applications, the completed pipe should be able to withstand normal curvatures as generally applicable in off-shore applications. The provision of tubing comprising an inner liner thus provides a barrier to permeation, and thus to leakage as a result of microcracks. A particular advantage of the use of metal for the inner liner is the prevention of explosive decompression in downhole and subsea applications. Explosive decompression results in the creation of blisters due to the rapid expansion of permeated molecules into the liner, under the effect of a sudden pressure drop. Since metals are impermeable to these molecules, the effects of explosive decompression are mitigated if the inner liner is metal.

Further, the metal inner liner can be roll formed, rather than extruded. Rolling is preferable because it provides a cost effective method to produce pipe with excellent roundness. In contrast, thermoplastic polymers can only be extruded, resulting in much lower tolerances. A high degree of roundness has increased benefits relating to the collapse pressures that the sheath is able to withstand. Further, rolling cannot be used for thick walls. Since the inner liner only requires a low wall thickness, rolling may be utilized. The production of a traditional tubing segment which has a wall of thick steel thus requires different and less accurate methods, thereby negatively influencing the roundness of the tubing, and thus negatively effecting the maximum applicable collapse pressures. The use of a thin metal liner in a continuous process thus facilitates the use of rolling rather than extruding.

Rolling is more accurate, leading to an increased collapse rating. Collapse is dependent on the material stiffness, the wall-thickness and the roundness of the material. The collapse-rating is thus increased due to an increased production accuracy. This is a still further advantage of the use of an inner liner in a composite tubing over the provision of a single-wall thick tubing segment.

In embodiments, the inner liner comprises one or more of steel, nickel alloys, nickel chrome, nickel copper alloys, titanium, titanium alloys. The inner liner may also comprise a high yield strength grade titanium, more preferably grade 4 titanium and/or grade 5 titanium and/or grade 12 titanium. In alternative embodiments, the inner liner comprises a polymer material, preferably a thermoplastic polymer material. An important material property for the inner liner, resulting from the choice of material from the above options, is the ductility, which is preferable for micro-crack mitigation. These materials thus have good intrinsic material properties such as ductility and already reduce the negative effects of corrosion by the fluid that is transported through the tubing segment. The provision of these materials also further increases the allowable loads. In conventional tubing the provision of these types of materials is not viable since the thick walls would require too much material. As a result, the tubing would become too expensive. Since in the disclosure of the present invention only a relatively thin liner is required, the material options are widened.

In an embodiment, the inner liner is welded to the tubing connector and/or to the second tubing connector. If the inner liner is welded to the tubing connector, the connection between the sheath and the tubing connector is strengthened.

In an embodiment, the tubing connector and/or the second tubing connector comprises titanium, preferably a high yield strength grade titanium, more preferably grade 4 titanium and/or grade 5 titanium and/or grade 12 titanium. In an embodiment, the inner liner and the tubing connector both comprise titanium, preferably wherein the second tubing connector also comprises titanium. The provision of a tubing connector and inner liner comprising titanium leads to excellent material properties. Because the inner liner is relatively thin, compared to single-wall tubing, the costs are maintained at reasonable levels. As the connector does not require a gripping surface for torsional loads which are expected for conventional threaded systems, the total material costs of the tubing connector are kept relatively low. As a result, high yield strength grade titanium may be used. In addition, since the materials of the inner liner and the tubing connector are the same (or similar), they can be welded by conventional methods, which increases the strength of the connection between the sheath and the tubing connector.

In an alternative embodiment, the tubing connector and the inner liner may be of different materials. In such a case, a bi-metal welding ring may be utilized to couple the inner liner and the tubing connector. The bi-metal welding ring is a cylindrical member having one material on a first end and another material on a second end. This bi-metal ring ensures a welded connection between the metal of the inner liner and the metal of the tubing connector. If the tubing connector is e.g. titanium, a first end of the bi-metal welding ring is also titanium. If the inner liner is made of e.g. a nickel alloy, a second end of the bi-metal ring is also a nickel alloy. The titanium tubing connector may be welded to the titanium first end of the bi-metal welding ring and the nickel-alloy inner liner may be welded to the nickel-alloy second end of the bi-metal ring.

The formation of such a bi-metal ring may be performed by explosion welding or friction stir welding. Other manufacturing techniques may also be used to create the bi-metal ring.

An advantage of the provision of a tubing connector comprising titanium, in particular a high yield strength grade titanium, is that the diameter of the connector may be decreased. In conventional snap fit hydraulic connectors, the minimum diameter is limited by the yield strength and modulus of elasticity (Young's Modulus or E-Modulus) of the material. As the diameter is reduced, the relative displacement under hydraulic pressure of the material to allow connection is increased. For example, when a pressurized fluid is used, the relative radial movement of the surface of the coupling end, needed to allow for alignment of the attachment members, is increased as the diameter of the material is reduced. That is, the local allowable deformation which is required to achieve sufficient displacement of the surface of the coupling end to align the attachment members is increased. As the modulus of elasticity of titanium is roughly half of conventional material such as steel. The use of titanium may thus decrease the minimum diameter of the tubing connector, while still offering high performance qualities. This opens the possibilities of application of segmented tubing in more applications, without acceding to the customary periodic workovers and replacements. In a preferred embodiment of the invention, the tubing connector is made from a material having a Young's modulus of less than about 180 GPa, preferably of less than about 160 GPa, more preferably of less than about 140 GPa, still more preferably of less than about 120 GPa.

In an embodiment, the tubing segment has a density lower than about 3000 kg/m3 at degrees Celsius, preferably lower than about 2000 kg/m3 at 25 degrees Celsius, more preferably lower than about 1800 kg/m3 at 25 degrees Celsius, still more preferably lower than about 1500 kg/m3 at 25 degrees Celsius. The provision of a tubing having a relatively low density ensures that the weight of the tubing, in relation to the medium it is suspended in, is low. It is noted that this density refers to the average density of a completed tubing comprising a plurality of tubing segments. In practice, this is the same as the average density of a single tubing segment. The total average weight thus includes the sheath and the connectors required to connect tubing segments. The total average weight does not include the fluid that is to be transported. Having a pipe with a low density means that the suspended weight in a well or in the ocean is reduced by a buoyancy effect. This further reduces the net forces that need to be applied to a tubing hanger. This allows for more completed pipes to be attached to a single vessel, without negatively affecting the vessels loading capacity due to the hanging weight of riser pipes.

In an embodiment, the outer wall comprises a fiber-reinforced material. The provision of a tubing having an outer wall with fiber-reinforced material may provide a light weight of the tubing. This allows use of a lighter and less expensive pulling system to deliver the required forces for downhole applications. Also, more pipes may be applied to a vessel for off-shore applications. Also, the maximum tensile/yield strength required of the tubing may be reduced because the pipe does not need to support so much of its own weight. The fiber-reinforced material further has the benefit that it is corrosion-resistant, thereby solving many of the problems of conventional tubing. It also has excellent material properties in terms of maximum applicable loads.

In an embodiment, the outer wall may comprise fibers set within a thermoset polymer matrix. By providing the fibers within a thermoset polymer matrix, the material can be provided with good structural integrity, even upon the application of increased temperatures.

In an embodiment, the thermoset polymer matrix comprises at least an epoxy resin. In an embodiment, the thermoset polymer matrix comprises one or more of polyester, epoxy, dicyclopentadiene, polyurethane, phenolic polymers, bismaleimide resin, and/or phthalonitrile. In still further embodiments additives of nano silica and/or core shell rubber may be used.

In an embodiment, the thermoset polymer matrix material may have a glass transition temperature of at least about 120 degrees Celsius, preferably of at least about 160 degrees Celsius, more preferably of at least about 180 degrees Celsius, still more preferably of at least about 200 degrees Celsius, most preferably of at least about 220 degrees Celsius, measured by Differential Scanning calorimetry (DSC).

The glass transition temperature is measured with Differential Scanning calorimetry (DSC). While the glass transition temperature may also be measured using different measurement techniques, such as Dynamic Mechanical Analysis (DMA), it shall be appreciated that a measurement technique which is different from DSC will likely result in different glass transition temperatures. The glass transition temperatures described in this document should be determined with DSC. If another measurement technique is used, a conversion should be applied to ensure these values correspond to what would be found if DSC were used.

DSC is a thermo-analytical technique in which the difference in the amount of heat required to increase the temperature of a sample and reference is measured as a function of temperature. Both the sample and reference are maintained at nearly the same temperature throughout the experiment. Generally, the temperature program for a DSC analysis is designed such that the sample holder temperature increases linearly as a function of time. The reference sample should have a well-defined heat capacity over the range of temperatures to be scanned. An example standard test method for assignment of the glass transition temperatures by DSC is given in ASTM E1356-08(2014).

The provision of a polymer material having the above glass transition temperatures may provide operability of the production tubing under the high temperatures in e.g. a production well. These glass transition temperatures may aid in ensuring that the outer wall of the sheath does not become too viscous.

In an embodiment, the outer wall comprises fibers within a thermoplastic polymer matrix, preferably comprising one or more of polyolefin, polyethylene, polyamide, polyvinylidene fluoride, polyether ether ketone. An advantage of the provision of an outer wall comprising fibers within a thermoplastic polymer matrix is that it has high ductility.

In an embodiment, the thermoplastic polymer matrix material may have a glass transition temperature of at least about 40 degrees Celsius, preferably of at least about 60 degrees Celsius, more preferably of at least about 80 degrees Celsius, still more preferably of at least about 100 degrees Celsius, most preferably of at least about 120 degrees Celsius, measured by Differential Scanning calorimetry (DSC).

In an embodiment, the fibers of the fiber-reinforced material may comprise one or more of carbon fiber, glass fiber, aramid fiber, and/or basalt fiber. In an embodiment, the fibers of the fiber-reinforced material may comprise pitch based carbon fiber and/or pan based carbon fiber.

In an embodiment, the fiber-reinforced material may have an ultimate tensile strength of at least about 2500 MPa, preferably of at least about 5000 MPa, more preferably of at least about 7000 MPa. In an embodiment, the ultimate tensile strength is lower than 8000 MPa. In an embodiment, the fiber-reinforced material may have an ultimate tensile strength of between 2500 and 8000 MPa, preferably of between 5000 and 8000 MPa, more preferably of between 7000 and 8000 MPa.

In an embodiment, the fiber-reinforced material may have a modulus of elasticity of between 60 and 590 GPa, preferably of between 200 and 400 GPa, more preferably of between 200 and 250 GPa. The ultimate tensile strength and the modulus of elasticity denoted above are values of dry fibers. In measuring these characteristics, the fibers are free of resin.

In an embodiment, the fiber-reinforced material may comprise PX35 and/or T700 carbon fiber.

In an embodiment, the tubing segment has an uninterrupted length of between about 2 and 100 meters, preferably of between about 4 and 50 meters, more preferably of between 8 and 20 meters, most preferably of about 12 meters. In on-shore embodiments, the tubing segment may have an uninterrupted length of between about 10 and 20 meters, preferably between about 12 to 18 meters. In off-shore embodiments, the tubing segment may have an uninterrupted length of between about 12 to 60 meters, preferably between about 15 to 50 meters.

In an embodiment, the sheath has an outer diameter of less than about 500 millimeters, preferably of less than about 350 millimeters, more preferably of less than about 140 millimeter, still more preferably of less than about 70 millimeters.

In an embodiment, the sheath has an inner diameter of more than about 45 millimeters, preferably of more than about 80 millimeters, more preferably of more than about 125 millimeters, still more preferably of more than about 300 millimeters.

In an embodiment, wherein the sheath has a wall thickness of less than about 60 millimeters, preferably of less than about 40 millimeters, more preferably of less than about 30 millimeters, still more preferably less than about 20 millimeters, and most preferably of less than about 5 millimeters.

In an embodiment, the outer wall comprises a fiber-reinforced material; and the tubing connector and/or the second tubing connector comprises a binding end, wherein the fiber-reinforced material of the outer wall of the sheath binds to the binding end of the tubing connector and/or the second tubing connector. This approach to bind the outer wall material to the tubing connector ensures in an incredibly big increase in structural integrity of the tubing segment. By binding the fiber-reinforced material to the binding end of the tubing connector, an integral connection is formed between the sheath and the tubing connector. The conventional weak point of segmented tubing is the interface of the connector with the part of the tubing to which the connector is attached. This is mitigated by the approach of binding the fiber-reinforced material to the binding end of the tubing connector, resulting in a far stronger tubing segment.

In an embodiment, the binding end of the tubing connector and/or the second tubing connector comprises fiber-deflecting units, wherein said fiber-deflecting units are arranged to guide fibers of the fiber-reinforced material of the outer wall over the binding end of the tubing connector and/or the second tubing connector. If the fibers are guided over the surface of the binding end without fiber-deflecting units, they will slip. To make sure a fiber can be guided from the sheath to the binding end and back, the fiber-deflection units are provided so that the fiber may be disposed over the binding without slipping. In addition, the transition of the fibers over the fiber-deflecting units ensures that the fiber does not have sudden changes in direction, which would induce weak points in the connection between the fibers and the binding end.

In an alternative embodiment, an outer surface of the binding end of the tubing connector and/or the second tubing connector, comprises fiber-reception grooves as the fiber-deflection units, wherein the fibers extend over the binding end, through the fiber-reception grooves. In an embodiment, an outer surface of the binding end of the tubing connector and/or the second tubing connector comprises radially extending projections as the fiber-deflection units, wherein the fibers extend over the binding end, and are disposed between the projections. These embodiments also allow for the provision of an integral connection between the sheath and the tubing connector.

According to an aspect of the invention, there is provided a tubing connector, comprising: a binding end; and a male coupling end having a tapered outer surface, wherein said tapered outer surface has a decreasing diameter, moving away from the binding end; or a female coupling end having a flared inner surface, wherein said flared inner surface has an increasing diameter, moving away from the binding end, wherein said binding end comprises fiber-deflecting units, arranged to guide fibers of a fiber-reinforced outer wall of a tubular over the binding end. The provision of a tubing connector comprising a binding end ensures that the outer wall of a tubing sheath may be integrally formed with the binding end of the tubing connector. The coupling end of the connector may be connected to another coupling end by virtue of an axial load, instead of a torsional load, as previously explained, thereby reducing the need for high amounts of expensive material to be used. Further, the use of fiber-deflection units further increases the structural integrity of the connection between an outer wall of a sheath and the binding end of the tubing connector.

In an embodiment, a female coupling end of a tubing connector comprises a passage connecting an outer surface of the female coupling end to the flared inner surface, said passage being arranged to allow pressurized fluid to be injected between the flared inner surface of the female coupling end and a tapered outer surface of a male coupling end of an opposing tubing connector. This arrangement allows for a better fit between two connectors. The passage allows for pressurized fluid to be injected in the space between the male and female coupling ends, thereby forcing the two opposing surfaces away from one another.

In an embodiment, said tapered outer surface or said flared inner surface comprises a number of attachment members, said number of attachment members being arranged to interlock with an opposing set of attachment members on a surface of an opposing tubing connector. In a preferred embodiment, the attachment members are circumferential grooves. In a still further preferred embodiment, the circumferential grooves are axially spaced.

In an embodiment, the fiber-deflection units comprise fiber-reception grooves in an outer surface of the binding end, wherein the grooves are arranged to guide the fibers over the first binding end. In an embodiment, an outer surface of the binding end comprises radially extending projections as the fiber-deflection units, wherein the radially extending projections are arranged to retain the fibers on the binding end. The provision of radially extending projections on the binding end ensures that the fibers of the outer wall of the sheath can be guided over the binding end, between the projections, to ensure a gradual change of direction of the tensile forces on the fibers so that the fibers can wind around the binding end without a sudden change of direction. As a result, the tensile strength of the fibers is not negatively influenced while still achieving a strong interlocking connection between the sheath and the tubing connector.

In an embodiment, the radially extending projections are conical or rounded. The projections being conical or rounded ensures that the fibers can be easily disposed between the projections, without the fibers catching on sharp edges of the projections.

In an embodiment, the projections may comprise a cylindrical stem. A cylindrical stem ensures an easier automated production process of the projections. For the production process of the tubing connector having a binding end, with the projections disposed on the binding end, it is preferable to have a cylindrical stem since that provides a surface area having a constant thickness, along its length-direction, contrary to a purely conical projection. The provision of a cylindrical portion ensures that the projections can be readily held before they are connected to the binding end. In an embodiment, the cylindrical stem ends with a rounded or conical section.

In an embodiment, one or more projections may be provided with a flange, said flange being connected to a base portion of the projections. Having a flange connected to the projections ensures that the process of welding the projections to the binding end when the tubing connector is produced is easier. In alternative embodiments, the projections may be integrally formed with the binding end, or protrude through openings in the binding end. In still further embodiments, the projections may be provided with additional components and/or structures integrally formed therewith, to keep the fibrous material positioned between the projections. Such components and/or structures may be barbs, hooks, ridges, clasps, or the like.

In an embodiment, the projections have a maximum diameter of between 1 mm and mm, preferably between 2 mm and 10 mm, more preferably between 3 mm and 8 mm, most preferably between 4 and 6 mm.

In an embodiment, the projections are distributed over the binding end, in the form of a regular pattern and/or with a density gradient and/or with a constant density. This ensures that during the winding of the outer wall of the sheath of the tubing, the orientation of the binding end of the tubing connector is of no relevance to the production process.

In an embodiment, the ratio of the distance between two projections to the diameter of the projections may be greater than 1, preferably greater than 3. In an embodiment, the density of the projections may be at most 1 projection per square centimeter, preferably per 2 square centimeter, more preferably per 5 square centimeter. This ensures that the welding tool to attach the projections to the binding end is able to reach in between the projections.

According to an aspect of the invention, there is provided a tubing connector, comprising: a sheath end, and a male coupling end having a tapered outer surface, wherein said tapered outer surface has a decreasing diameter, moving away from the sheath end; or a female coupling end having a flared inner surface, wherein said flared inner surface has an increasing diameter, moving away from the sheath end, wherein said tapered outer surface or said flared inner surface comprises a number of attachment members, said number of attachment members being arranged to interlock with an opposing set of attachment members on a surface of an opposing tubing connector, and wherein the tubing connector comprises a high yield strength grade titanium. Any feature provided in relation to other tubing connectors according to the present invention may be applied to this aspect of the invention as well. In an embodiment, said attachment members are circumferential grooves. In an embodiment the tubing connector is made substantially from a high yield strength grade titanium. In an embodiment, said high yield strength grade titanium comprises grade 4 titanium and/or grade 5 titanium and/or grade 12 titanium. The provision of a high yield strength grade titanium as a material for the tubing connector ensures that a smaller diameter tubing connector may be achieved, in particular in relation to the relative displacement of the attachment members provided on the surface of the coupling end. The increased relative displacement of the material without reaching the point of plastic deformation ensures that a smaller diameter tubing connector may be achieved.

In an aspect of the invention, there is provided tubing for carrying a fluid, said tubing comprising a plurality of tubing segments in accordance with any of the embodiments described hereinbefore, said tubing segments being connected in series, preferably wherein said tubing segments are connected with at least two tubing connectors in accordance with any of the embodiments described hereinbefore.

In an aspect of the invention, there is provided a production or injection installation comprising a subsurface well and tubing, said tubing being located in the subsurface well, wherein said tubing is comprised of tubing segments according to any of the embodiments described hereinbefore.

In an aspect of the invention, there is provided a method of manufacturing tubing, the method comprising the steps of: providing an inner liner; connecting a tubing connector according to any of the embodiments described hereinbefore to the inner liner; winding a fibrous material around the inner liner and at least a part of the tubing connector; providing a polymer material to the fibrous material; and preferably impregnating the fibrous material with a polymer resin. The polymer material is arranged to consolidate the fibrous material.

In an embodiment, the polymer material is a thermosetting polymer material, the method further comprising the step of curing the thermosetting polymer material, preferably using a chemical reaction and/or by heating the thermosetting polymer material.

In an embodiment, the thermosetting polymer is heated via induction heating.

In an embodiment, an electrically conducting additive is provided in the polymer material. This promotes induction heating and/or improves conductive heating

In an embodiment, the inner liner comprises a metal, wherein preferably the inner liner is welded to the tubing connector. In a preferred embodiment, the welding is performed in an environment with a low oxygen content, preferably in an inert environment, more preferably in an argon environment.

In an embodiment, the inner liner and the tubing connector comprise titanium.

In an aspect of the invention, there is provided a method of connecting two tubing segments, comprising the steps of: providing a first tubing segment, said tubing segment being in accordance with any of the embodiments described hereinbefore; providing a second tubing segment, said tubing segment being in accordance with any of the embodiments described hereinbefore; wherein the first tubing segment comprises a tubing connector comprising a male coupling end and wherein the second tubing segment comprises a tubing connector comprising a female coupling end, positioning the male coupling end of the first tubing segment in line with the female coupling end of the second tubing segment; partially sliding the tapered outer surface of the male coupling end into the flared inner surface of the female coupling end; and securing the attachment members of the tapered outer surface to the attachment members of the flared inner surface to secure the male coupling end in the female coupling end. In a preferred embodiment, the attachment members are circumferential grooves. In a particularly preferred embodiment, the circumferential grooves are axially spaced. These axially spaced grooves are thus non-helical and ensure that the connectors cannot be unscrewed.

In an embodiment, the step of securing the attachment members, preferably circumferential grooves, comprises: injecting a fluid, preferably oil, under pressure between the male coupling end and the female coupling end, wherein the fluid creates a space between the tapered outer surface of the male coupling end and the flared inner surface of the female coupling end, thereby pushing the attachment members of the flared inner surface away from the attachment members of the tapered outer surface, fully sliding the tapered outer surface of the male coupling end into the flared inner surface of the female coupling end, thereby completing the insertion and aligning the attachment members of the tapered outer surface with the attachment members of the flared inner surface, releasing the pressure of the fluid, thereby reducing the space between the tapered outer surface and the flared inner surface to allow interlocking the attachment members of the tapered outer surface and the attachment members of the flared inner surface. In the relaxed state, prior to deformation of the surfaces of the coupling ends, the attachment members on the surfaces of the male and female coupling ends may have a negative clearance relative to each other.

In an aspect of the invention, there is provided a method of producing mineral oil or natural gas from a subsurface reservoir, comprising the steps of; providing tubing according to any of the embodiments described hereinbefore in a subsurface reservoir; and extracting subsurface oil or gas through the tubing to provide said mineral oil or natural gas.

### BRIEF DESCRIPTION OF THE DRAWINGS

The features and advantages of the invention will be appreciated upon reference to the following drawings, in which:

FIG. 1 is an isometric schematic view of the sheath of the tubing segment according to an embodiment of the present invention;

FIG. 1A is a cross-sectional view of the sheath of FIG. 1 according to an embodiment of the present invention;

FIG. 2 is an isometric view of a tubing connector according to an embodiment of the present invention;

FIG. 3 is a side view of the tubing connector of FIG. 2 according to an embodiment of the present invention;

FIG. 4 is a longitudinal cross-sectional view of the tubing connector of FIGS. 2 and 3, taken at the line A-A of FIG. 3, according to an embodiment of the present invention; and

FIG. 5 is an isometric view of a tubing connector according to an embodiment of the present invention; and

FIG. 6 is a longitudinal cross-sectional view of the tubing connector of FIG. 5 according to an embodiment of the present invention; and

FIG. 7 is an isometric view of a tubing connector according to an embodiment of the present invention; and

FIG. 8 is a longitudinal cross-sectional view of the tubing connector of FIG. 7 according to an embodiment of the present invention; and

FIG. 9 is a cut-out view of the tubing connector according to an embodiment of the present invention, connected to the tubing segment according to an embodiment of the present invention; and

FIG. 10 is a front view of the tubing connector, connected to the inner liner of the sheath of the tubing segment according to an embodiment of the present invention;

FIG. 11 is a cross-sectional view of one side of tubing according to an embodiment of the present invention, showing a female coupling end and a male coupling end in connected state;

FIG. 12 is a flow chart illustrating a method of manufacturing tubing in accordance with an embodiment of the present invention; and

FIG. 13 is a flow chart illustrating a method of coupling two tubing segments in accordance with an embodiment of the present invention.

### DESCRIPTION OF ILLUSTRATIVE EMBODIMENTS

The following is a description of certain embodiments of the invention, given by way of example only and with reference to the drawings.

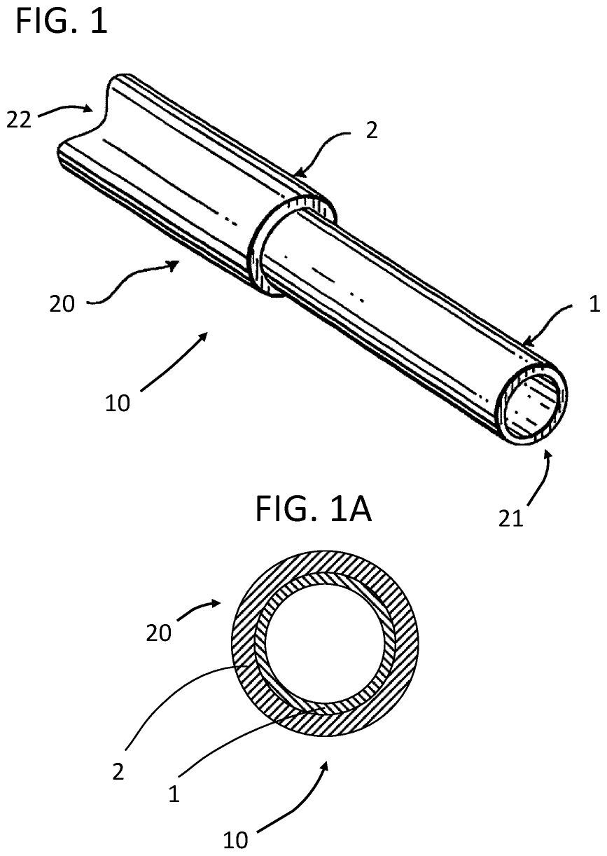

Referring to FIG. 1, an isometric schematic view of the sheath 20 of the tubing segment 10 according to an embodiment of the present invention is shown. The sheath 20 comprises an inner liner 1 and an outer wall 2. The inner liner 1 is exposed as the outer wall 2 is retracted. In normal operation, the outer wall 2 would extend over the entire length of the sheath 20. The sheath 20 further comprises a first open end 21 and a second open end 22. The first open end 21 of the sheath 20 is to be connected to a tubing connector 3 according to the invention.

Referring to FIG. 1A a cross-sectional view of the sheath 20 of FIG. 1 according to an embodiment of the present invention is shown. The cross-sectional view of the sheath 20 shows the inner liner 1 surrounded by the outer wall 2. In a preferred embodiment, the outer wall 2 and the inner liner 1 directly contact one another. In other embodiments of the invention, further layers of tubing may be disposed between the inner liner 1 and the outer wall 2. As shown in the figure, the outer wall 2 has a greater thickness than the inner liner 1. The outer wall 2 provides a high degree of structural integrity to the sheath 20 and thus to the tubing segment 10. The inner liner 1 preferably comprises an isotropic impermeable material which mitigates the effects of potential microcracks in the surface of the outer wall 2 of the tubing segment 10.

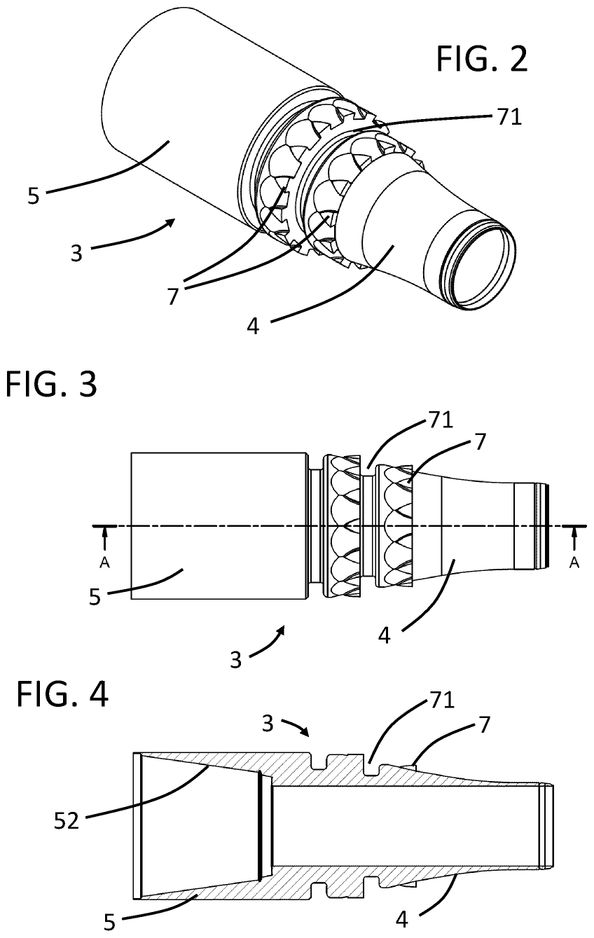

Referring to FIG. 2, an isometric view of a tubing connector 3 according to an embodiment of the present invention is shown. Referring also to FIG. 3, a side view of the tubing connector of FIG. 2 is shown. The tubing connector 3 comprises a binding end 4 and a female coupling end 5. The binding end 4 comprises a number of fiber-deflecting units 7, arranged to guide fibers 23 of the outer wall 2 over the binding end 4 of the tubing connector 3. The fiber-deflecting units 7 help prevent slipping of the fibers 23 of the outer wall 2 during binding. As a result, the fiber-deflecting units 7 lead to increased strength of the connection between the tubing connector 3 and the sheath 20 of the tubing segment 10. In the shown embodiment, the fiber deflecting units 7 are projections extending from the surface of the binding end 4 of the tubing connector 3. These projections are formed by cutting away material therebetween, e.g. by milling. In the shown embodiment substantially triangular elements are formed to gradually guide the fibers 23 of the outer wall 2 in a curved manner so that they can fall in a circumferential trench 71. The trench 71 is arranged to receive the fibers 23 of the outer wall 2 and spool them so that they adhere to the binding end 4 of the tubing connector 3. Provision of the fiber-deflecting units 7 may allow for a reduced depth of the trenches 71, as they aid in preventing slipping of the fibers 23 off the outer wall 2.

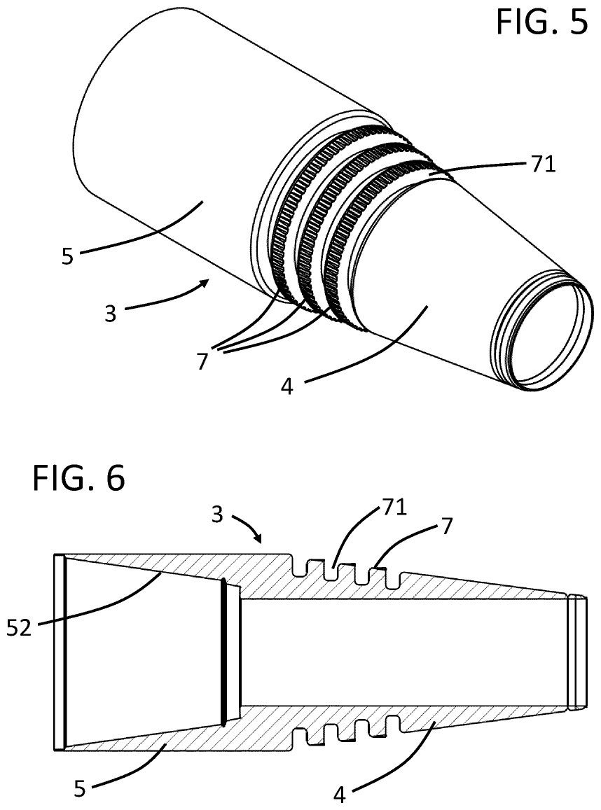

Referring to FIG. 4, a longitudinal cross-sectional view of the tubing connector of FIGS. 2 and 3 is shown, taken at the line A-A of FIG. 3. The cross-sectional view clearly shows the shape of the trenches 71 in relation to the substantially triangular projections of the fiber-deflecting units 7. The shown embodiment comprises a female coupling end 5 having a flared inner surface 52, onto which attachment members 8 are disposed, which are not shown in the figure. The flared inner surface 52 of the female coupling end 5 has an increasing diameter, when moving away from the binding end 4 of the tubing connector. It shall be appreciated that this is the other way around for a male coupling end 6, which would have a tapered outer surface 62. The tapered outer surface 62 of a male coupling end 6 would also comprise attachment members 8. As can be seen in the cross-sectional view, not much material is needed to form the tubing connector 3. At the point where the binding end 4 of the tubing connector 3 starts to increase in thickness, the inner diameter of the flared surface 52 starts to increase as well, thereby reducing the wall thickness of the tubing connector 3. As a result, the tubing connector 3 has relatively low material costs.

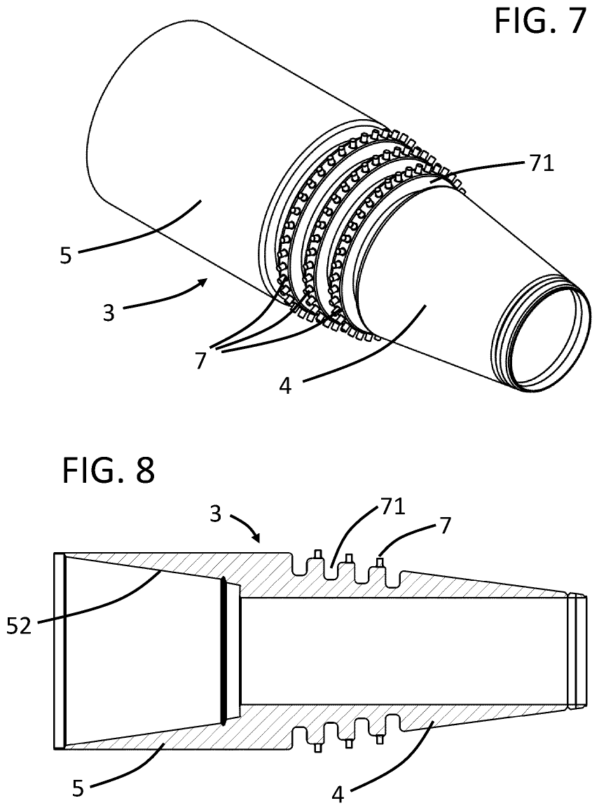

Referring to FIG. 5, an isometric view of another tubing connector according to an embodiment of the present invention is shown. Referring to FIG. 6, a longitudinal cross-sectional view of the tubing connector of FIG. 5 according to an embodiment of the present invention is shown. As seen in the isometric view of FIG. 5, the tubing connector 3 comprises a binding end 4 and a female coupling end 5. The binding end 4 comprises fiber-deflecting units in the form of fiber-reception grooves disposed on the wall sections between the four circumferential trenches 71. In a preferred embodiment, these fiber-reception grooves are milled into the surface of the tubing connector. These fiber-reception grooves work in substantially the same way as the substantially triangular projections as shown in FIG. 2. The fibers 23 of the outer wall 2 of the sheath 20 are wound around the inner liner 1 of the sheath and disposed over at least a part of the binding end 4 of the tubing connector 3. The fibers 23 are guided between the fiber-reception grooves 7 of the binding end 4 and guided into the trenches 71 so that they may be wound around the binding end 4 of the tubing connector 3 with a minimized risk of slipping. This ensures a tight fit between the outer wall 2 of the sheath and the tubing connector 3. As shown in the cross-sectional view of FIG. 6, the female coupling end 5 of the tubing connector 3 comprises a flared inner surface 52. Again, a male coupling end 6 may also be utilized in embodiments of the tubing connector 3.

Referring to FIG. 7, an isometric view of another tubing connector according to another embodiment of the present invention is shown. Referring to FIG. 8, a longitudinal cross-sectional view of the tubing connector of FIG. 7 according to an embodiment of the present invention is shown. As shown in the embodiment of FIG. 7, the tubing connector 3 comprises a binding end 4 and a female coupling end 5. The binding end 4 comprises a plurality of fiber-deflection units 7, disposed on three wall sections between the four circumferential trenches 71. In the shown embodiment, the fiber-deflection units 7 are substantially cylindrical projections which protrude from the surface of the tubing connector 3. These projections may e.g. be welded onto the surface of the tubing connector 3. In other embodiments, these projections may be milled into the original surface of the tubing connector 3. Again, the fibers 23 of the outer wall 2 of the sheath 2 may be provide between the fiber-deflecting units 7 and guided into the trenches 71 disposed in the surface of the tubing connector 3. As a result, the fibers 23 may be prevented from slipping away, allowing for a limited depth of the trenches 71, while maintaining a strong connection between the binding end 4 of the tubing connector 3 and the outer wall 2 of the sheath 20. As a result, a tubing segment 10 having a high structural integrity is formed, while keeping material costs low and acceding to operational performance requirements. FIG. 8 shows how the substantially cylindrical projections 7 protrude from the surface of the binding end 4 of the tubing connector 3.

In reference to the previous embodiments of the tubing connector 3, it shall be understood that various combinations and adaptations are applicable. For example, it may be advantageous to combine the substantially triangular fiber-deflection units with the substantially cylindrical projections. In other embodiments, the trench(es) 71 may be entirely omitted, if the fiber-deflection units 7 provide sufficient guidance to the fibers 23 of the outer wall 2 of the sheath 20.

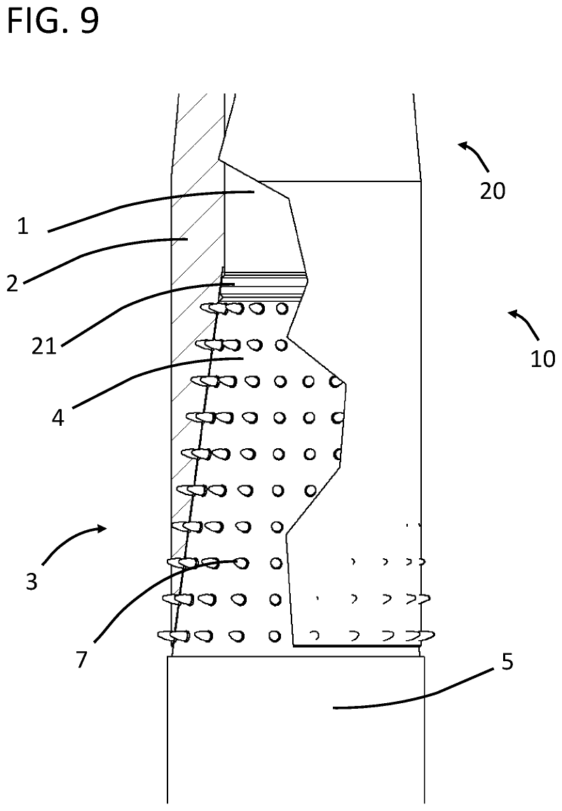

Referring to FIG. 9 a cut-out view of a tubing connector 3 connected to the tubing segment 10 according to an embodiment of the present invention is shown. The figure shows the tubing segment 10 comprising a sheath 20 having an inner liner 1, an outer wall 2 and a first open end 21. The tubing segment 10 further comprises a tubing connector 3. The tubing connector 3 is connected to the first open end 21 of the sheath 20. In a preferred embodiment, the tubing connector 3 is welded to the inner liner 1 of the sheath 20. The tubing connector comprises a binding end 4 and a female coupling end 5. As can be seen, the binding end 4 of the tubing connector 3 comprises a plurality of fiber-deflection units 7 in the form of projections or pins, which extend radially outward, and are provided across the binding end 4 of the tubing connector 3. These projections 7 are arranged to receive the fibers 23 of the outer wall 2 of the sheath 20 of the tubing segment 10. These fibers 23 extend between the projections 7 of the tubing connector 3, thereby creating an integral connection between the sheath and the tubing connector 3 to form the tubing segment 10. As explained, in a preferred embodiment, both the inner liner 1 and the tubing connector 3 are made of titanium. The titanium inner liner 1 and the titanium tubing connector 3 may be welded together since they are both titanium. However, this must be done in a oxygen-low environment, preferably in an argon-environment. Since the tubing segments 10 are manufactured in a normal production facility, i.e., not at the well site or on the vessel prior to deployment, the environments may be easier controlled, thereby allowing for the use of welded titanium. By using titanium, the corrosion regularly found in steel tubing segments is reduced, the diameter may be reduced because of the lower modulus of elasticity, and the inner liner 1 and the tubing connector 3 may be welded together, increasing the strength of the connection and thus the structural integrity of the tubing segment 10.

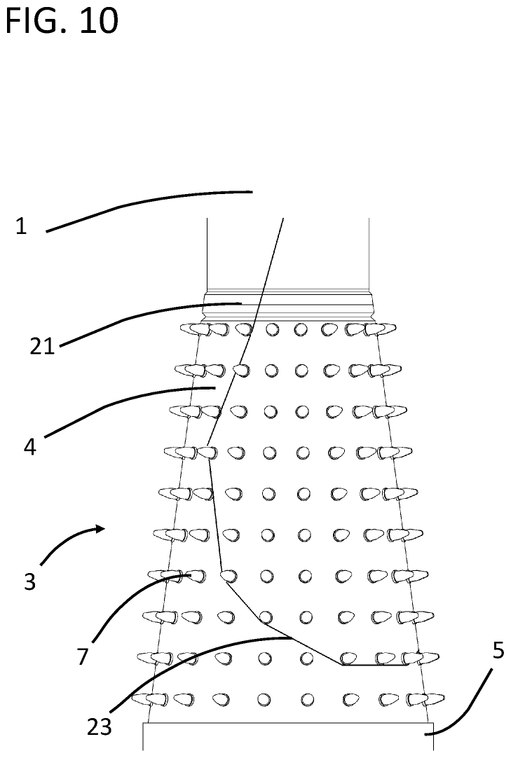

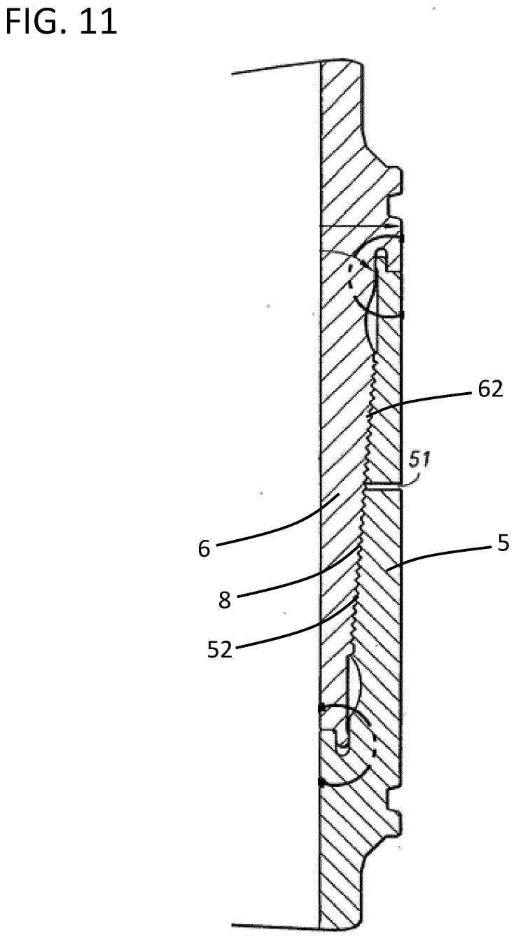

Referring to FIG. 10, a front view of the tubing connector 3, connected to the inner liner 1 of the sheath 20 of the tubing segment 10, according to an embodiment of the present invention is shown. The figure shows a tubing connector 3 having a binding end 4 and a female coupling end 5. The inner liner 1 is connected to the tubing connector 3, preferably via welding. On the tubing connector 3, a number of projections 7 are disposed, between which the fibers 23 of the outer wall 2 may be guided. As shown in the figure, one such fiber 21 is directed over the inner liner 1 of the tubing segment 10 between the projections 7. The projections 7 allow for a gradual directional change of the fiber 21 to ensure the fiber does not encounter disadvantageous amounts of local stress.

Different layers of fibers 23 may be wound around the inner liner 1 of the binding end 4 of the tubing segment 10 at different winding angles relative to a central sheath axis. The low angle fibers 23 are mainly responsible for carrying the axial loads and providing the connection to the tubing connector 3. Therefore, particular attention must be given to the winding pattern of the low angle fibers 23 when transitioning to the tubing connector 3 and to the path they follow between the projections 7. To provide a smooth and distributed transfer of axial loads from the fibers 23 to the tubing connector 3, a gradual change of fiber direction is desired. This translates into so called wide turns, e.g. turns with a large radius. This is shown in FIG. 10. An even distribution of loads onto the projections 7 is also achieved by ensuring that the turns of each new low angle fiber 21 is placed at a different location along the tubing connector 3 than the previous one. The high angle fibers, provided in the outer wall 2 are mainly responsible for carrying the circumferential loads i.e. pressure and collapse loads. When transitioning onto the tubing connector 3, these high angle fibers maintain their path and angle. This method will sandwich the low angle fibers 23 into a stable laminate, thereby increasing the integrity and stability of the low angle fibers 23. This approach may equally be used in conjunction with other example embodiments of the tubing connectors 3 described herein.

The transition of fibers from the inner liner 1 onto the tubing connector 3 may be a weak point of the tubing segment 10. To design a fiber transition that is as strong or stronger than the tubing itself, additional local fibers may be added. This leads to the creation of a tubing connection upset, e.g. the increased thickness of the outer wall 2, closer to the tubing connector 3. The maximum outer diameter of the pipe body as well as the maximum outer diameter of the tubing connector 3 may be determined by industry standards, such as for example the maximum inner diameter of the BOP rams, and/or the production casing in downhole applications. Additional local fibers may be added to increase the strength at the transition point while not exceeding the maximum connection upset diameter.

Referring to FIG. 11, a cross-sectional view of one side of tubing according to an embodiment of the present invention is shown, showing a female coupling end 5 and a male coupling end 6 being connected. As shown in the figure, both the flared inner surface 52 of the female coupling end 5 and the tapered outer surface 52 of the male coupling end 6 comprise attachment members 8. In the shown embodiment, the attachment members 8 are circumferential grooves. The female coupling end 5 of the tubing connector 3 comprises a passage 51 arranged to allow the injection of pressurized fluid between the female coupling end 5 and the male coupling end 6. The passage allows for a fluid connection between the outer surface of the female coupling end 5 and the flared inner surface 52 of the female coupling end 5. As a result, a pressure may be applied between the flared inner surface 52 of the female coupling end 5 and the tapered outer surface 62 of the male coupling end 6, thereby forcing the surfaces, and thus their attachment members 8 apart, so that they may be aligned. Once they are aligned, in an axial direction, the pressure may be released via passage 51 so that the attachment members 8 of the flared inner surface 52 and the tapered outer surface 62 may interlock.

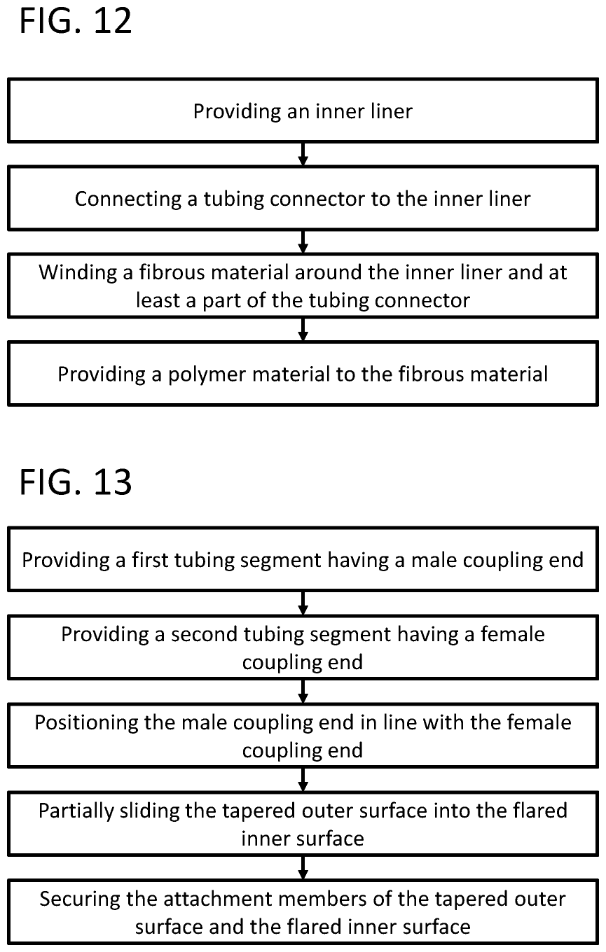

Referring to FIG. 12, a flow chart illustrating a method of manufacturing a tubing segment 10 in accordance with an embodiment of the present invention is shown. The figure shows the steps of providing an inner liner 1; connecting a tubing connector 3 to the inner liner 1; winding a fibrous material 23 around the inner liner 1 and at least a part of the tubing connector 3; and providing a polymer material to the fibrous material. This forms the outer wall 2 having an integral connection with the tubing connector 3.

Referring to FIG. 13, a flow chart illustrating a method of coupling two tubing segments 10 in accordance with an embodiment of the present invention is shown. The figure shows the steps of providing a first tubing segment 10 having a male coupling end 6; providing a second tubing segment 10 having a female coupling end 5; positioning the male coupling end 6 in line with the female coupling end 6; partially sliding the tapered outer surface 62 of the male coupling end 6 into the flared inner surface 52 of the female coupling end 5; and securing the attachment members 8 of the tapered outer surface 62 and the flared inner surface 52.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. Tubing segment (10) for construction of tubing for transporting a fluid, the tubing segment comprising;
a sheath (20) comprising;
an inner liner (1);
an outer wall (2);
a first open end (21); and
a second open end (22),
said sheath extending between the first open end and the second open end; and
a tubing connector (3),
wherein the first open end of the sheath is connected to the tubing connector, said tubing connector comprising:
a male coupling end having a tapered outer surface, wherein said tapered outer surface has a decreasing diameter, moving away from the first open end of the sheath; or
a female coupling end having a flared inner surface, wherein said flared inner surface has an increasing diameter, moving away from the first open end of the sheath, wherein said tapered outer surface or said flared inner surface comprises a number of attachment members, said number of attachment members being arranged to interlock with an opposing set of attachment members on a surface of an opposing tubing connector.

2. The tubing segment according to claim 1, further comprising a second tubing connector, wherein the second open end of the sheath is connected to the second tubing connector, said second tubing connector comprising:
a male coupling end having a tapered outer surface, wherein said tapered outer surface has a decreasing diameter, moving away from the first open end of the sheath; or
a female coupling end having a flared inner surface, wherein said flared inner surface has an increasing diameter, moving away from the first open end of the sheath,
wherein said tapered outer surface or said flared inner surface comprises a number of attachment members, said number of attachment members being arranged to interlock with an opposing set of attachment members on a surface of an opposing tubing connector.

3. The tubing segment according to any of the preceding claims, wherein the first open end of the sheath is connected to a tubing connector comprising a male coupling end and wherein the second open end of the sheath is connected to a second tubing connector comprising a female coupling end.

4. The tubing segment according to any of the preceding claims, wherein the female coupling end comprises a passage connecting an outer surface of the female coupling end to the flared inner surface, said passage being arranged to allow pressurized fluid to be injected between the flared inner surface of the female coupling end and a tapered outer surface of a male coupling end of an opposing tubing connector.

5. The tubing segment according to any of the preceding claims, wherein the attachment members are circumferential grooves, preferably wherein the circumferential grooves are axially spaced.

6. The tubing segment according to any of the preceding claims, wherein the inner liner comprises an isotropic material.

7. The tubing segment according to any of the preceding claims, wherein the inner liner has a rupture strain rate of more than about 0.5%, preferably of more than about 5%, more preferably of more than about 20%.

8. The tubing segment according to any of the preceding claims, wherein the inner liner comprises metal and/or metal alloys.

9. The tubing segment according to claim 8, wherein the inner liner comprises one or more of steel, nickel alloys, nickel chrome, nickel copper alloys, titanium, titanium alloys.

10. The tubing segment according to claim 8 or 9, wherein the inner liner is welded to the tubing connector and/or to the second tubing connector.

11. The tubing segment according to any of the preceding claims, wherein the tubing connector and/or the second tubing connector comprises titanium, preferably a high yield strength grade titanium, more preferably grade 4 titanium and/or grade 5 titanium and/or grade 12 titanium.

12. The tubing segment according to any of the preceding claims, wherein the inner liner and the tubing connector both comprise titanium, preferably wherein the second tubing connector also comprises titanium.

13. The tubing segment according to any preceding claim, wherein the tubing segment has a density that of lower than about 3000 kg/m³ at 25 degrees Celsius, preferably lower than about 2000 kg/m³ at 25 degrees Celsius, more preferably lower than about 1800 kg/m³ at degrees Celsius, still more preferably lower than about 1500 kg/m³ at 25 degrees Celsius.

14. The tubing segment according to any preceding claim, wherein the outer wall comprises a fiber-reinforced material.

15. The tubing segment according to claim 14, wherein the outer wall comprises fibers within a thermoset polymer matrix.

16. The tubing segment according to claim 15, wherein the thermoset polymer matrix comprises at least an epoxy resin.

17. The tubing segment according to claim 15 or 16, wherein the thermoset polymer matrix comprises one or more of polyester, epoxy, dicyclopentadiene, polyurethane, phenolic polymers, bismaleimide resin, and/or phthalonitrile.

18. The tubing segment according to any of claims 15 to 17, wherein the thermoset polymer matrix material has a glass transition temperature of at least about 120 degrees Celsius, preferably of at least about 160 degrees Celsius, more preferably of at least about 180 degrees Celsius, still more preferably of at least about 200 degrees Celsius, most preferably of at least about 220 degrees Celsius.

19. The tubing segment according to claim 14, wherein the outer wall comprises fibers within a thermoplastic polymer matrix, preferably comprising one or more of polyolefin, polyethylene, polyamide, polyvinylidene fluoride, polyether ether ketone.

20. The tubing segment according to any of claims 14 to 19, wherein the fibers of the fiber-reinforced material comprise one or more of carbon fiber, glass fiber, aramid fiber, and/or basalt fiber.

21. The tubing segment according to any of claims 14 to 20, wherein the fiber-reinforced material comprises pitch based carbon fiber and/or pan based carbon fiber.

22. The tubing segment according to any of claims 14 to 21, wherein the fiber-reinforced material has an ultimate tensile strength of between 2500 and 8000 MPa, preferably of between 5000 and 8000 MPa, more preferably of between 7000 and 8000 MPa.

23. The tubing segment according to any of claims 14 to 22, wherein the fiber-reinforced material has a modulus of elasticity of between 60 and 590 GPa, preferably of between 200 and 400 GPa, more preferably of between 200 and 250 GPa.

24. The tubing segment according to any of claims 14 to 23, wherein the fiber-reinforced material comprises PX35 and/or T700 carbon fiber.

25. The tubing segment according to any of the preceding claims, wherein the tubing segment has an uninterrupted length of between about 2 and 100 meters, preferably of between about 4 and 50 meters, more preferably of between 8 and 20 meters, most preferably of about 12 meters.

26. The tubing segment according to any of the preceding claims, wherein the sheath has an outer diameter of less than about 500 millimeters, preferably of less than about 350 millimeters, more preferably of less than about 140 millimeter, still more preferably of less than about 70 millimeters.

27. The tubing segment according to any of the preceding claims, wherein the sheath has an inner diameter of more than about 45 millimeters, preferably of more than about 80 millimeters, more preferably of more than about 125 millimeters, still more preferably of more than about 300 millimeters.

28. The tubing segment according to any of the preceding claims, wherein the sheath has a wall thickness of less than about 60 millimeters, preferably of less than about 40 millimeters, more preferably of less than about 30 millimeters, still more preferably less than about 20 millimeters, and most preferably of less than about 5 millimeters.

29. The tubing segment according to any of the preceding claims,
wherein the outer wall comprises a fiber-reinforced material; and
wherein the tubing connector and/or the second tubing connector comprises a binding end,
wherein the fiber-reinforced material of the outer wall of the sheath binds to the binding end of the tubing connector and/or the second tubing connector.

30. The tubing segment according to claim 29, wherein the binding end of the tubing connector and/or the second tubing connector comprises fiber-deflecting units,
wherein said fiber-deflecting units are arranged to guide fibers of the fiber-reinforced material of the outer wall over the binding end of the tubing connector and/or the second tubing connector.

31. The tubing segment according to claim 30, wherein an outer surface of the binding end of the tubing connector and/or the second tubing connector, comprises fiber-reception grooves as the fiber-deflection units,
wherein the fibers extend over the binding end, through the fiber-reception grooves.

32. The tubing segment according to claim 30, wherein an outer surface of the binding end of the tubing connector and/or the second tubing connector comprises radially extending projections as the fiber-deflection units,
wherein the fibers extend over the binding end, and are disposed between the projections.

33. A tubing connector (3), comprising:
a binding end (4); and
a male coupling end (6) having a tapered outer surface, wherein said tapered outer surface has a decreasing diameter, moving away from the binding end; or
a female coupling end (5) having a flared inner surface (51), wherein said flared inner surface has an increasing diameter, moving away from the binding end,
wherein said binding end comprises fiber-deflecting units (7), arranged to guide fibers of a fiber-reinforced outer wall of a tubular over the binding end.

34. The tubing connector according to claim 33, wherein said tapered outer surface or said flared inner surface comprises a number of attachment members (8), said number of attachment members (8) being arranged to interlock with an opposing set of attachment members on a surface of an opposing tubing connector, wherein preferably the attachment members are circumferential grooves.

35. The tubing connector according to claim 33 or 34, wherein the fiber-deflection units comprise fiber-reception grooves in an outer surface of the binding end,
wherein the grooves are arranged to guide the fibers over the first binding end.

36. The tubing connector according to claim 33 or 34, wherein an outer surface of the binding end comprises radially extending projections as the fiber-deflection units,
wherein the radially extending projections are arranged to retain the fibers on the binding end.

37. The tubing connector according to claim 36, wherein the projections are conical or rounded and/or wherein the projections comprise a cylindrical stem.

38. The tubing connector according to claim 36 or 37, wherein the projections have a maximum diameter of between 1 mm and 15 mm, preferably between 2 mm and 10 mm, more preferably between 3 mm and 8 mm, most preferably between 4 and 6 mm.

39. The tubing connector according to any of claims 36 to 38, wherein the projections are distributed over the binding end, in the form of a regular pattern and/or with a density gradient and/or with a constant density.

40. The tubing connector according to any of claims 36 to 39, wherein the ratio of the distance between two projections to the diameter of the projections is greater than 1, preferably greater than 3.

41. The tubing connector according to any of claims 39 to 40, wherein the density of the projections is at most 1 projection per square centimeter, preferably per 2 square centimeter, more preferably per 5 square centimeter.

42. Tubing for carrying a fluid, said tubing comprising a plurality of tubing segments in accordance with any of claims 1 to 32, said tubing segments being connected in series, preferably wherein said tubing segments are connected with at least two tubing connectors in accordance with any of claims 33 to 41.

43. A production or injection installation comprising a subsurface well and tubing according to claim 42, said tubing being located in the subsurface well.

44. Method of manufacturing tubing, the method comprising the steps of:
providing an inner liner;
connecting a tubing connector according to any of claims 33 to 41 to the inner liner;
winding a fibrous material around the inner liner and at least a part of the tubing connector;
providing a polymer material to the fibrous material; and
preferably impregnating the fibrous material with a polymer resin.

45. The method of claim 44, wherein the polymer material is a thermosetting polymer material, the method further comprising the step of curing the thermosetting polymer material, preferably by heating the thermosetting polymer material.

46. The method of claim 44 or 45, wherein the inner liner comprises a metal, wherein preferably the inner liner is welded to the tubing connector.

47. The method of claim 45 or 46, wherein the thermosetting polymer is heated via induction heating.

48. The method of any of claims 44 to 47, wherein an electrically conducting additive is provided in the polymer material.

49. The method of any of claims 44 to 48, wherein the inner liner and the tubing connector comprise titanium.

50. Method of connecting two tubing segments, comprising the steps of:
providing a first tubing segment, said tubing segment being in accordance with any of claims 1 to 32;
providing a second tubing segment, said tubing segment being in accordance with any of claims 1 to 32;
wherein the first tubing segment comprises a tubing connector comprising a male coupling end and wherein the second tubing segment comprises a tubing connector comprising a female coupling end,
positioning the male coupling end of the first tubing segment in line with the female coupling end of the second tubing segment;
partially sliding the tapered outer surface of the male coupling end into the flared inner surface of the female coupling end; and
securing the attachment members of the tapered outer surface between the attachment members of the flared inner surface to secure the male coupling end in the female coupling end, preferably wherein the attachment members are circumferential grooves.

51. The method of claim 50, wherein the step of securing the attachment members, preferably circumferential grooves, comprises:
injecting a fluid, preferably oil, under pressure between the male coupling end and the female coupling end,
wherein the fluid creates a space between the tapered outer surface of the male coupling end and the flared inner surface of the female coupling end, thereby pushing the attachment members of the flared inner surface away from the attachment members of the tapered outer surface,
fully sliding the tapered outer surface of the male coupling end into the flared inner surface of the female coupling end, thereby completing the insertion and aligning the attachment members of the tapered outer surface with the attachment members of the flared inner surface,
releasing the pressure of the fluid, thereby reducing the space between the tapered outer surface and the flared inner surface to allow interlocking the attachment members of the tapered outer surface and the attachment members of the flared inner surface.

52. Method of producing mineral oil or natural gas from a subsurface reservoir, comprising the steps of;
providing tubing according to claim 42 in a subsurface reservoir; and
extracting subsurface oil or gas through the tubing to provide said mineral oil or natural gas.
